(19) United States
(12) Patent Application Publication
(10) Pub. No.: US 2016/0114286 A1
(43) Pub. Date: Apr. 28, 2016

(54) ABSORBENT FOR ACIDIC GAS SEPARATION AND METHOD FOR ACIDIC GAS SEPARATION

(71) Applicants: Hyundai Motor Company, Seoul (KR); Korea Institute of Energy Research, Daejeon (KR)

(72) Inventors: Shin-Tae Bae, Hwaseong (KR); Sungchan Nam, Daejeon (KR); Sungyeoul Park, Daejeon (KR); Yeoil Yoon, Daejeon (KR)

(21) Appl. No.: 14/919,198

(22) Filed: Oct. 21, 2015

(30) Foreign Application Priority Data
Oct. 24, 2014 (KR) 10-2014-0145542

(51) Int. Cl. B01D 53/14

(52) U.S. Cl. CPC B01D 53/1493; B01D 53/1475; B01D 2252/10; B01D 2252/20447

(57) ABSTRACT

Disclosed are an absorbent for acidic gas separation that include: an amount of about 1 wt % to 17.5 wt % of alkali-carbonate based on the total weight of the absorbent; an amount of about 1 wt % to 5.5 wt % of a heterocyclic amine compound based on the total weight of the absorbent; 1 wt % to 8 wt % of an alkyl substituent of the heterocyclic amine compound based on the total weight of the absorbent; and a residual amount of an aqueous solution; and a method for acidic gas separation that include: contacting the absorbent for acidic gas separation and a gas including an acidic gas.

### CROSS REFERENCE TO RELATED APPLICATION

The present application claims priority to Korean Patent Application No. 10-2014-0145542 filed on Oct. 24, 2014, the entire contents of which is incorporated herein for all purposes by this reference.

### FIELD OF THE INVENTION

The present invention relates to an absorbent for acidic gas separation and a method for acidic gas separation. The absorbent for acidic gas separation may absorb and separate an acidic gas at improved efficiency using reduced amount of energy, and may have stable composition. Further, the method may substantially improve efficiency and process stability in a process for acidic gas separation, and thus, may reduce energy and absorbent cost required for the process and increase process economic feasibility.

### BACKGROUND

Carbon dioxide is an acidic gas as one of six greenhouse gases which cause global warming and has a substantial amount of generation and anchorage. Among various methods for separating carbon dioxide discharged from energy industrial process, many researches such as a liquid phase absorption method which is the most excellent in view of economic feasibility have been conducted from the past.

In the liquid phase absorption method, an alkanolamine method using monoethanolamine, diethanolamine, triethanolamine, and the like, a Benfield process using potassium carbonate, and the like, have been most widely used.

The alkanolamine method includes about 20 to 30 wt % solution prepared by mixing various alkanolamines absorbing carbon dioxide with water, which has been commercially used since 1970s due to rapid carbon dioxide absorption capacity. However, the alkanolamine method may have problems. For example, excessive energy of about 4.0 to 4.2 GJ/ton CO₂ (in a case of MEA), may be consumed in a generation process, an oxidation reaction may occur by pollutant (O₂, SO₂, NOx) present in combustion exhaust gas, facilities made of carbon steel may be corroded, and the like.

In particular, in order to decrease high regeneration heat occurring during an operation by the alkanolamine method, an absorbent decreasing a carbamate bonding force has been developed by directly bonding carbon dioxide in alkanolamine with carbamate to allow methyl groups or ethyl groups to be attached around nitrogen atoms separating carbon dioxide which causes steric hindrance. Representative absorbent used in the alkanolamine method may be AMP (2-amino-2-methyl-1-propanol). The absorbent does not have a rapid absorption power of carbon dioxide as the same as methyl ethyl amine (MEA), but has reduced renewable energy. For example, the conventional KS-1 absorbent (Mitsubishi Heavy Industries, Ltd., Japan) using similar steric hindrance amine as a main material may have a renewable energy of about 2.8 to 3.2 GJ/ton CO₂.

Meanwhile, the Benfield process or a Catacarb process has been known as a representative method of collecting carbon dioxide which is an acidic gas by using a liquid phase alkali-material such as NaOH, Na₂CO₃, K₂CO₃, KOH, or the like. The Benfield process includes adding some alkanolamines (mainly, diethanolamine (DEA)) in order to overcome disadvantage that a reaction rate of carbon dioxide is low. The Catacarb process uses potassium carbon as a main material and using organic materials or inorganic materials which have not known as a reaction rate enhancer.

However, in the above-described methods, since an absorption column and a stripping column are required to be operated at a temperature of about 120° C. or greater in order to overcome generation of potassium bicarbonate, high energy may be consumed or an operation may be required to be performed under a gas flow pressure of about 10 atmosphere or greater.

Accordingly, a method capable of having higher acidic gas absorption capacity and separation capacity, decreasing required energy, and reducing the actual cost required for the process has been demanded to be developed.

The contents described as the related art have been provided only for assisting in the understanding for the background of the present invention and should not be considered as corresponding to the related art known to those skilled in the art.

### SUMMARY

In one aspect, the present invention provides an absorbent for acidic gas separation that may absorb and separate an acidic gas at improved efficiency using reduced energy, and may have stable composition.

In another aspect, provided is a method for acidic gas separation that may provide high efficiency and process stability in a process for acidic gas separation, and may reduce energy and absorbent cost required for the process to increase process economic feasibility.

In an exemplary embodiment of the present invention, provided is an absorbent for acidic gas separation including: an amount of about 1 wt % to 17.5 wt % of alkali-carbonate based on the total weight of the absorbent; an amount of about 1 wt % to 5.5 wt % of a heterocyclic amine compound based on the total weight of the absorbent; an amount of about 1 wt % to 8 wt % of an alkyl substituent of the heterocyclic amine compound based on the total weight of the absorbent; and a residual amount of an aqueous solution.

Further, a solid salt in an amount of about 0.5 wt % or less based on the total weight of the absorbent may be precipitated on the absorbent for acidic gas separation.

An absorption amount of carbon dioxide by the absorbent of the present invention may be about 1.160 mol CO₂/mol (solution) or greater.

The alkali-carbonate may include at least one selected from the group consisting of potassium carbonate (K₂CO₃), sodium carbonate (Na₂CO₃), sodium hydroxide (NaOH), potassium hydroxide (KOH), potassium bicarbonate (KHCO₃) and sodium bicarbonate (NaHCO₃).

The heterocyclic amine compound may include a compound represented by Chemical Formula 1 below:

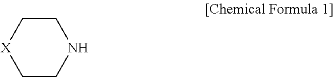

in Chemical Formula 1, X is —O—, —S—, or —NH—.

For example, the heterocyclic amine compound may include piperazine.

The alkyl substituent of the heterocyclic amine compound may include a compound represented by Chemical Formula 2 below:

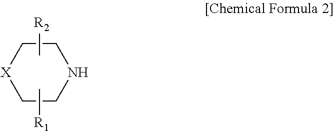

in Chemical Formula 2, X is —O—, —S—, or —NH—, and

R₁ and R₂ each is a straight or branched chain C₁ to C₄ alkyl group.

For example, the alkyl substituent of the heterocyclic amine compound may include 2-methyl piperazinea.

A weight ratio of the alkyl substituent of the heterocyclic amine compound to the heterocyclic amine compound may be from about 0.8 to about 1.5.

Further, a total content of the heterocyclic amine compound and the alkyl substituent of the heterocyclic amine compound may be of about 8 wt % to 12 wt % based on the total weight of the absorbent.

The alkali-carbonate may be included in an amount of 14 wt % to 17 wt % based on the total weight of the absorbent; piperazine may be included in an amount of 4 wt % to 5.5 wt % based on the total weight of the absorbent; 2-methyl piperazine is included in an amount of 4 wt % to 7 wt % based on the total weight of the absorbent; and the aqueous solution is included in a residual amount.

In addition, the absorbent may further include at least one additive selected from the group consisting of a corrosion inhibitor, a coagulant aid, an oxygen inhibitor and an anti-foaming agent.

In an exemplary embodiment of the present invention, also provided is a method for acidic gas separation. The method may include: contacting the absorbent for acidic gas separation as described herein and a gas including an acidic gas.

The absorbent for acidic gas separation and the gas including an acidic gas may be contacted under conditions of a temperature of about 5° C. to 90° C. and an atmospheric pressure of about 0.5 to 5.

Other aspects of the invention are disclosed infra.

### BRIEF DESCRIPTION OF THE DRAWINGS

The above and other objects, features and advantages of the present disclosure will be more apparent from the following detailed description taken in conjunction with the accompanying drawings:

FIG. 1 shows an exemplary image obtained after storing an absorbent prepared in Example 2 at room temperature for 10 hours according to an exemplary embodiment of the present invention;

FIG. 2 shows an exemplary image obtained after storing an absorbent prepared in Comparative Example 4 at room temperature for 10 hours; and

FIG. 3 shown an exemplary image obtained after storing an absorbent prepared in Comparative Example 9 at room temperature for 10 hours.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the absorbent for acidic gas separation and the method for acidic gas separation according to various exemplary embodiments of the present invention are described in more detail.

In an exemplary embodiment of the present invention, the absorbent for acidic gas separation may include: an amount of about 1 wt % to 17.5 wt % of alkali-carbonate based on the total weight of the absorbent; an amount of about 1 wt % to 5.5 wt % of a heterocyclic amine compound based on the total weight of the absorbent; an amount of about 1 wt % to 8 wt % of an alkyl substituent of the heterocyclic amine compound based on the total weight of the absorbent; and a residual amount of an aqueous solution.

The present inventors have conducted a research into a method capable of selectively absorbing and separating only an acidic gas in combustion exhaust gas from a boiler, and have confirmed through exemplary experiments that the absorbent including the above-described alkali-carbonate, the heterocyclic amine compound, and the alkyl substituent in specific contents thereof may absorb and separate the acidic gas at an improved efficiency while consuming reduced amount of energy. Further, the absorbent may have stable composition even after a long period of using time.

In particular, by using the absorbent for acidic gas separation according to an exemplary embodiment of the present invention, an improved performance for absorbing carbon dioxide may be provided while consuming reduced amount of energy. Moreover, since precipitation or deposition of a solid salt due to a reaction between components does not substantially occur while using a large content range of alkali-carbonate, stable composition may be provided.

For instance, the solid salt may be precipitated in an amount of about 0.5 wt % or less or about 0.1 wt % or less on the absorbent for acidic gas separation, and further, the solid salt may not be substantially precipitated on the absorbent for acidic gas separation.

In addition, as described above, the absorbent for acidic gas separation according to an exemplary embodiment of the present invention may have an improved performance for absorbing carbon dioxide while consuming relatively low energy. For example, the absorbent for acidic gas separation may consume about 60 (kJ/mol CO₂) or less of energy and may have an absorption amount of carbon dioxide of about 1.160 mol CO₂/mol (solution) or greater.

The absorbent for acidic gas separation may include an amount of about 1 wt % to 17.5 wt % of alkali-carbonate, an amount of about 15 wt % to 17 wt % of alkali-carbonate, or particularly an amount of about 16 wt % to 17 wt % of alkali-carbonate, based on the total weight of the absorbent.

In the conventional absorbents used for acidic gas separation, the alkali-carbonate may be included in an amount of up to about 15 wt % or 16 wt % based on the total weight of the absorbent. When the alkali-carbonate has a content in the above-described range or greater, an excessive amount of solid salt may be precipitated in the absorbent, and thus excessive energy may be consumed during the acidic gas separation.

On the contrary, the absorbent for acidic gas separation according to an exemplary embodiment may include the alkali-carbonate in an amount of up to about 1 wt % to 17.5 wt % based on the total weight of the absorbent. In particular, even though the alkali-carbonate is included in an amount of about 15 wt % or greater or 16 wt % or greater, stable composition in which precipitation of the solid salt is not deposited may be provided, and thus energy required for acidic gas separation may also be maintained at a reduced level. The above-described characteristics of the absorbent for acidic gas separation according to an exemplary embodiment of the present invention may be obtained by including the above-described heterocylic amine compound and the alkyl substituent thereof with together, each of which may have a particular content.

Specific examples of the alkali-carbonate are not significantly limited, but for example, potassium carbonate (K₂CO₃), sodium carbonate (Na₂CO₃), sodium hydroxide (NaOH), potassium hydroxide (KOH), potassium bicarbonate (KHCO₃), sodium bicarbonate (NaHCO₃), or mixtures of two or more kinds thereof may be used as the alkali-carbonate.

As described above, the absorbent for acidic gas separation according to an exemplary embodiment may include an amount of about 1 wt % to 5.5 wt % of the heterocyclic amine compound based on the total weight of the absorbent; and an amount of about 1 wt % to 8 wt % of the alkyl substituent of the heterocyclic amine compound based on the total weight of the absorbent, together with the above-described alkali-carbonate.

In the present specification, ‘the heterocyclic amine compound’ refers to an alicyclic or aromatic ring compound in which one or more amine functional groups are included in a backbone of the ring. The heterocyclic amine compound may further include other hetero elements, for example, nitrogen, oxygen, sulfur, and the like, in addition to the nitrogen element included in the amine functional group.

In addition, the alkyl substituent of the heterocyclic amine compound refers to a compound in which one or more alkyl groups are substituted in the ring of the heterocyclic amine compound, and specifically, a compound in which one or more straight or branched chain C1 to C10 alkyl groups are substituted at carbon of the aliphatic or aromatic ring of the heterocyclic amine compound.

The absorbent for acidic gas separation according to an exemplary embodiment includes an amount of about 1 wt % to 17.5 wt %, an amount of about 15 wt % to 17 wt %, or particularly an amount of about 16 wt % to 17 wt % of the alkali-carbonate based on the total weight of the absorbent; an amount of about 1 wt % to 5.5 wt %, or particularly an amount of about 4 wt % to 5.5 wt % of the heterocyclic amine compound based on the total weight of the absorbent; an amount of about 1 wt % to 8 wt %, or particularly an amount of about 4 wt % to 7 wt % of the alkyl substituent of the heterocyclic amine compound based on the total weight of the absorbent to thereby absorb and separate the acidic gas at improved efficiency while consuming reduced energy, and maintain the stable composition even for a long period of using time.

When the content of the alkali-carbonate is included less than the predetermined amount, for example, less than about 1 wt %, in the absorbent for acidic gas separation, sufficient acidic gas absorption performance may not be obtained. When the content of the alkali-carbonate is included greater than the predetermined amount, for example, greater than about 17.5 wt %, in the absorbent for acidic gas separation, at the time of a process without using a slurry pump, the precipitation of the solid salt may be deposited from the absorbent for acidic gas separation, such that a pipe line may be blocked which may cause accidents, and stability of composition may be deteriorated when using the absorbent for a long period of time.

In addition, when each content of the heterocyclic amine compound and the alkyl substituent of the heterocyclic amine compound in the absorbent for acidic gas separation is included than the predetermined amount, for example, less than about 1 wt %, respectively, sufficient acidic gas absorption performance. When each content of the heterocyclic amine compound and the alkyl substituent of the heterocyclic amine compound in the absorbent for acidic gas separation is included greater than the predetermined amount, for example, greater than about 5.5 wt % or 8 wt %, respectively, precipitation of the solid salt may be deposited from the absorbent for acidic gas separation, and stability of composition may be deteriorated when using the absorbent for a long period of time.

In particular, when the heterocyclic amine compound or the alkyl substituent of the heterocyclic amine compound is included alone in an amount of about 8 wt % or greater, or particularly about 10 wt % or greater based on the total weight of the absorbent, an excessive amount of solid salt may be precipitated in an absorbent for acidic gas separation to be prepared. On the contrary, when the heterocyclic amine compound is mixed with the alkyl substituent of the heterocyclic amine compound, the solid salt may not be precipitated even at a range in which a total content of the heterocyclic amine compound and the alkyl substituent of the heterocyclic amine compound is about 8 wt % or greater, or about 10 wt % or greater based on the total weight of the absorbent, and stable composition may be maintained even when using the absorbent for a long period of time, and the acidic gas absorption capacity may also be substantially improved. Specifically, in the absorbent for acidic gas separation according to an exemplary embodiment, a total content of the heterocyclic amine compound and the alkyl substituent of the heterocyclic amine compound may be in an amount of about 8 wt % to 12 wt % based on the total weight of the absorbent.

The heterocyclic amine compound may include, without limitation, a compound represented by Chemical Formula 1 below:

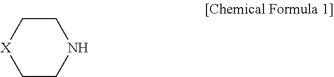

in Chemical Formula 1, X is —O—, —S—, or —NH—.

In addition, an exemplary heterocyclic amine compound may include piperazine.

The alkyl substituent of the heterocyclic amine compound may include, without limitation, a compound represented by Chemical Formula 2 below:

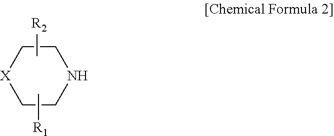

in Chemical Formula 2, X is —O—, —S—, or —NH—, and R₁ and R₂ each is a straight or branched chain C1 to C4 alkyl group. In Chemical Formula 2, R₁ and R₂ are bound to carbons at other positions except for X and —NH— in the hexagonal ring, respectively.

Exemplary alkyl substituent of the heterocyclic amine compound may include 2-methyl piperazine.

For example, in the absorbent for acidic gas separation, the alkali-carbonate may be included in an amount of about 14 wt % to 17 wt % based on the total weight of the absorbent, piperazine may be included in an amount of about 4 wt % to 5.5 wt % based on the total weight of the absorbent, 2-methyl piperazine may be included in an amount of about 4 wt % to 7 wt % based on the total weight of the absorbent, and the aqueous solution may be included in a residual amount.

A weight ratio of the alkyl substituent of the heterocyclic amine compound to the heterocyclic amine compound may be from about 0.8 to about 1.5 or, in particular, from about 0.9 to about 1.3.

The absorbent for acidic gas separation may include a residual amount of an aqueous solution in addition to the above-described components. The aqueous solution may refer to a solvent including water as a main component, and may further include other components having solubility in addition to water.

The absorbent for acidic gas separation may further include any additives that can be generally used in the related arts for additional improvement or reinforcement of physical properties in addition to the above-described components. For example, the absorbent may further include a corrosion inhibitor, a coagulant aid, an oxygen inhibitor, an anti-foaming agent, mixtures of two or more kinds thereof, and the like.

Meanwhile, the present invention also provides a method for acidic gas separation. The method may include: contacting the absorbent for acidic gas separation as described herein and a gas including an acidic gas.

The method for acidic gas separation may substantially improve efficiency and process stability in the process for acidic gas separation, and further may reduce energy and absorbent cost required for the process to increase process economic feasibility. In particular, since the absorbent for acidic gas separation according to an exemplary embodiment of the present invention as described above is used in the method for acidic gas separation, precipitation or deposition of the solid salt may not occur even for a long period of using time, such that stability and reliability of the process may be increased. Moreover, an improved performance for absorbing carbon dioxide while consuming low energy may be provided to thereby increase economic feasibility and efficiency of the process.

Detailed descriptions of the absorbent for acidic gas separation in the present exemplary embodiment of the present invention include all of the above-description regarding the absorbent for acidic gas separation according to an exemplary embodiment as described above.

Examples of the gas including the acidic gas are not significantly limited. For example, the gas including the acidic gas may be a gas including carbon dioxide after burning fuel such as combustion exhaust gas from a boiler, a gas including carbon dioxide from a gas mixed with petroleum raw materials (methane, ethylene, acetylene, carbon monoxide, and the like) such as naphtha cracking, a gas including carbon dioxide in landfills and waste decomposition gas, a gas such as carbon dioxide included while stripping carbonic acid material bound to metal elements such as steel manufacturing cement, aluminum, and magnesium.

In addition, a method and an apparatus which are usable in the step of contacting the absorbent for acidic gas separation and the gas including an acidic gas are not significantly limited, and may be, for example, generally known methods and apparatuses such as an absorption column type, a spray manner, a bubble column type, and the like, including fillings or plates.

Further, reaction conditions which are applicable in the contacting the absorbent for acidic gas separation and the gas including an acidic gas are not significantly limited, and for example, the contacting step may be performed under conditions of a temperature of about 5° C. to 90° C. and an atmospheric pressure of about 0.5 to 20.

Thus, according to the present invention, provided are an absorbent for acidic gas separation that may consume reduced amount of energy, absorb and separate an acidic gas at improved efficiency, and have a stable composition; and a method for acidic gas that may substantially improve efficiency and process stability in a process for acidic gas separation, and may reduce energy and absorbent cost required for the process to increase process economic feasibility.

Specifically, when the absorbent for acidic gas separation and the method for acidic gas separation are used, since precipitation or deposition of a solid salt due to a reaction between components may not occur while using a wide content range of alkali-carbonate which is one of major components of the absorbent, stable composition may be provided, and stability and reliability of the method for acidic gas separation using the absorbent may be increased. In addition, the absorbent may have an improved performance for absorbing carbon dioxide while consuming relatively low energy to thereby increase economic feasibility and efficiency of the method for acidic gas separation.

### EXAMPLE

The present invention will be described in more detail in the following Examples. Meanwhile, the following examples are for merely exemplifying the present invention, and therefore, the scope of the present invention is not limited to the following examples.

### Example and Comparative Example

### Preparation of Absorbent for Acidic Gas Separation

Each absorbent for acidic gas separation was prepared by providing materials shown in Table 1 below at room temperature, physically mixing the materials with a ball mill and a mixer, putting and stiffing the mixed materials into a stirring bath at a temperature of about 50° C. Specific compositions of the prepared absorbents for acidic gas separation are shown in Table 1 below.

In addition, after contacting the prepared absorbents for acidic gas separation and the combustion exhaust gas from the boiler (about 12% of the content ratio of carbon dioxide), an absorption amount of carbon dioxide which was absorbed by using a stirrer was measured by gas chromatography, and consumed energy was calculated by using a differential calorimetry analyzer,

TABLE 1

| | | Main Composition | | | CO₂ Absorption | |
|---|---|---|---|---|---|---|
| | | of Absorbent | | | Amount (mol | Consumed Energy |
| | | (wt %) | | | CO₂ )/(mol | (Regeneration Heat, |
| Classification | | K₂CO₃ | PZ | 2MPZ | [Solution]) | −ΔH_{abs}) [(kJ/mol CO₂)] |
| Example | 1 | 15 | 5 | 5 | 1.166 | 58.342 |
| | 2 | 17 | 5 | 5 | 1.174 | 57.212 |
| | 3 | 17 | 5 | 7 | 1.165 | 55.119 |
| Comparative | 1 | MEA (30) | | | 0.600 | 80.980 |
| Example | 2 | 15 | 10 | — | 1.155 | 61.258 |
| | 3 | 15 | — | 10 | 1.158 | 56.654 |

| | | | | |
|---|---|---|---|---|
| 4 | 17 | 10 | — | Solid salt was obtained. |
| 5 | 17 | — | 10 | Solid salt was obtained. |
| 6 | 15 | 11 | — | Solid salt was obtained. |
| 7 | 15 | — | 11 | Solid salt was obtained. |
| 8 | 17 | 6 | 6 | Solid salt was obtained. |
| 9 | 18 | 5 | 5 | Solid salt was obtained. |

1) Residual composition of absorbent: H₂O, about 0.01 wt % of an anti-foaming agent based on the total weight of the absorbent, about 0.01 wt % of a corrosion inhibitor based on the total weight of the absorbent)

2) MEA: Methyl ethyl amine, PZ: piperazine, 2MPZ: 2-methyl-piperazine

As shown in Table 1 above, it was confirmed that as compared to the absorbent of Comparative Example 1 having methyl ethyl amine as a main component and the absorbents of Comparative Examples 2 and 3 using any one of piperazine or 2-methyl-piperazine as a main component, the absorbents of Examples 1 to 3 using both of piperazine and 2-methyl-piperazine had greater performance for absorbing carbon dioxide while consuming lower energy. In particular, the absorbents of Examples 1 to 3 had performance for absorbing carbon dioxide of about 1.160 mol CO₂/mol (solution) or greater while consuming energy of about 60 (kJ/mol CO₂) or less.

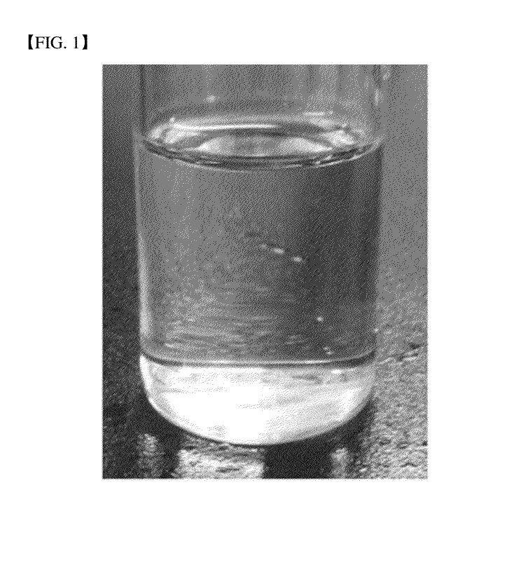

In addition, in the absorbents of Examples 1 to 3, it was confirmed that even at a range in which the alkali-carbonate was used at a range of about 14 wt % to 17 wt % based on the total weight of the absorbent, and the total content of piperazine and 2-methyl-piperazine was of about 8 wt % to 12 wt % based on the total weight of the absorbent, stable composition was provided, and even when the absorbents were maintained at room temperature for a long period of time after being prepared, the precipitation of the solid salt was not deposited. Further, FIG. 1 shows an exemplary image obtained after storing an exemplary absorbent prepared in Example 2 at room temperature for 10 hours according to an exemplary embodiment of the present invention. As shown in FIG. 1, it was confirmed that the precipitation of the solid salt was not substantially present in the absorbent of Example 2.

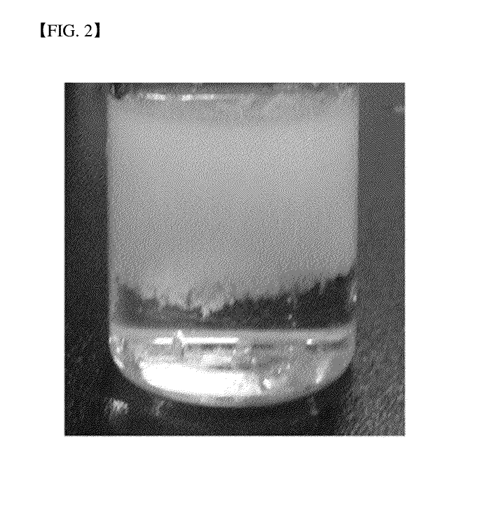

Meanwhile, it was confirmed that the precipitation of the solid salt was deposited and present on the absorbent of Comparative Example 4 including about 17 wt % of alkali-carbonate based on the total weight of the absorbent and about 10 wt % of piperazine based on the total weight of the absorbent. Specifically, FIG. 2 is an image obtained after storing an absorbent prepared in Comparative Example 4 at room temperature for about 10 hours. As shown in FIG. 2, it was confirmed that precipitation of an excessive amount of solid salt was deposited in the absorbent of Comparative Example 4.

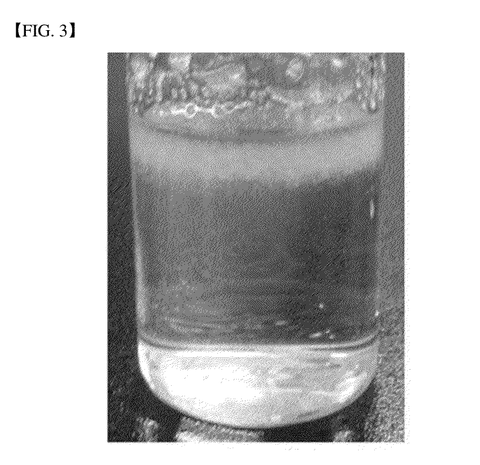

In addition, it was also confirmed that when the absorbent of Comparative Example 8 prepared by including about 17 wt % of alkali-carbonate based on the total weight of the absorbent, but also including about 6 wt % of piperazine based on the total weight of the absorbent and about 6 wt % of 2-methyl-piperazine based on the total weight of the absorbent and the absorbent of Comparative Example 9 prepared by including about 18 wt % of alkali-carbonate based on the total weight of the absorbent, but also including about 5 wt % of piperazine based on the total weight of the absorbent and about 5 wt % of 2-methyl-piperazine based on the total weight of the absorbent were stored at room temperature for about 10 hours after being prepared, the precipitation of the solid salt was deposited. Specifically, it was confirmed from FIG. 3 that the precipitation of the solid salt was deposited on the absorbent of Comparative Example 9.

That is, since precipitation or deposition of the solid salt due to a reaction between components does not substantially occur while using a wide content range of alkali-carbonate which is one of major components of the absorbent, the absorbents of Examples may provide stable composition and may increase stability and reliability of the process using the absorbent. In addition, the absorbents of Examples may consume reduced energy and have improved performance for absorbing carbon dioxide to increase economic feasibility and efficiency of the process.

What is claimed is:

1. An absorbent for acidic gas separation comprising:
an amount of about 1 wt % to 17.5 wt % of alkali-carbonate based on the total weight of the absorbent;
an amount of about 1 wt % to 5.5 wt % of a heterocyclic amine compound based on the total weight of the absorbent;
an amount of about 1 wt % to 8 wt % of an alkyl substituent of the heterocyclic amine compound based on the total weight of the absorbent; and
a residual amount of water,
wherein an absorption amount of carbon dioxide is about 1.160 mol CO₂/mol (solution) or greater

2. The absorbent for acidic gas separation of claim 1, wherein a solid salt in an amount of about 0.5 wt % or less based on the total weight of the absorbent is precipitated on the absorbent for acidic gas separation.

3. The absorbent for acidic gas separation of claim 1, wherein the alkali-carbonate includes at least one selected from the group consisting of potassium carbonate (K₂CO₃), sodium carbonate (Na₂CO₃), sodium hydroxide (NaOH), potassium hydroxide (KOH), potassium bicarbonate (KHCO₃) and sodium bicarbonate (NaHCO₃).

4. The absorbent for acidic gas separation of claim 1, wherein the heterocyclic amine compound includes a compound represented by Chemical Formula 1 below: 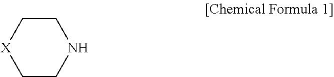
in Chemical Formula 1, X is —O—, —S—, or —NH—.

5. The absorbent for acidic gas separation of claim 1, wherein the heterocyclic amine compound includes piperazine.

6. The absorbent for acidic gas separation of claim 1, wherein the alkyl substituent of the heterocyclic amine compound includes a compound represented by Chemical Formula 2 below: 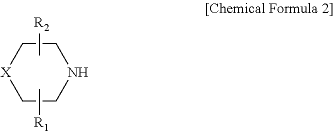
in Chemical Formula 2, X is —O—, —S—, or —NH—, and
R₁ and R₂ each is a straight or branched chain C₁ to C₄ alkyl group.

7. The absorbent for acidic gas separation of claim 1, wherein the alkyl substituent of the heterocyclic amine compound includes 2-methyl piperazine.

8. The absorbent for acidic gas separation of claim 1, wherein a weight ratio of the alkyl substituent of the heterocyclic amine compound to the heterocyclic amine compound is from about 0.8 to about 1.5.

9. The absorbent for acidic gas separation of claim 1, wherein a total content of the heterocyclic amine compound and the alkyl substituent of the heterocyclic amine compound is of about 8 wt % to 12 wt %.

10. The absorbent for acidic gas separation of claim 1, wherein the alkali-carbonate is included in an amount of about 14 wt % to 17 wt % based on the total weight of the absorbent; piperazine is included in an amount of about 4 wt % to 5.5 wt % based on the total weight of the absorbent; 2-methyl piperazine is included in an amount of about 4 wt % to 7 wt % based on the total weight of the absorbent; and water is included in a residual amount.

11. The absorbent for acidic gas separation of claim 1, further comprising:
at least one additive selected from the group consisting of a corrosion inhibitor, a coagulant aid, an oxygen inhibitor and an anti-foaming agent.

12. A method for acidic gas separation comprising:
contacting the absorbent for acidic gas separation of claim 1 and a gas including an acidic gas.

13. The method for acidic gas separation of claim 12, wherein
the absorbent for acidic gas separation and the gas including an acidic gas are contacted under conditions of a temperature of about 5° C. to 90° C. and an atmospheric pressure of about 0.5 to 5.
